(19) United States
(12) Patent Application Publication
(10) Pub. No.: US 2018/0058455 A1
(43) Pub. Date: Mar. 1, 2018

(54) FLOAT SWITCH DEVICE FOR SUBMERSIBLE PUMPS

(71) Applicant: PEDROLLO S.P.A., San Bonifacio (IT)

(72) Inventor: Silvano PEDROLLO, San Bonifacio (IT)

(73) Assignee: PEDROLLO S.P.A., San Bonifacio (IT)

(21) Appl. No.: 15/556,720

(22) PCT Filed: Mar. 10, 2016
(86) PCT No.: PCT/IB2016/051367

§ 371 Date: Sep. 8, 2017

(30) Foreign Application Priority Data
Mar. 10, 2015 (IT) BO2015A000116

(51) Int. Cl. F04D 15/02; H01H 35/18

(52) U.S. Cl. CPC F04D 15/0218; H01H 35/186

(57) ABSTRACT

The float switch device for submersible pumps, comprises a float member (2) constrained to a flexible cable (3) which is electrically connected to the driving member of the pump (10). The flexible cable (3) is associated with a tilting support member (5), mounted in tilting manner outside the body of the pump (10) on a pin (6) with a substantially horizontal axis. The float member (2) is provided with a switch member (24) electrically connected to said flexible cable (3) and actuatable by actuator means (22) mobile as a function of the liquid level (L1, L2), for controlling the starting and stopping of the pump (10).

### TECHNICAL FIELD

The present invention regards a float switch device for submersible pumps and the like.

### PRIOR ART

Use of submersible pumps for supplying water from relatively deep vats, reservoirs or wells, for conveying waste water and liquid manure and other similar uses, for domestic, civil and industrial purposes, is currently known. Such submersible pumps are generally made up of a delivery body in which an impeller, in communication with the external environment, and a generally cylindrical motor body, adapted to house a driving member, are arranged.

According to a known solution, the submersible pumps may be provided with an external float switch device predisposed to control the starting and stopping of the pump according to the liquid level in the recipient. In particular, the float switch device starts the pump when the liquid level reaches a preset height and stops it when the level drops to a minimum value.

According to a known solution, the float is connected to the body of the pump by a connection member which allows the same float to follow the liquid level variations. The float is connected to a switch which controls the starting and stopping of the pump, being suitably operated depending on the position assumed by the same float.

EP 0 821 165 illustrates an example of a control device for actuating a submersible pump comprising a float rigidly constrained to the axis of a rotary member for controlling the switch, arranged inside the body of the pump, so as to cause the rotation of such axis following the liquid level.

U.S. Pat. No. 4,540,891 illustrates a float switch device for pumps that can be operated according to the liquid level. The switch device comprises a float member associated with a cable that carries two conductors electrically connected to the driving member of the pump. The cable is connected to a pin point so that the switch device is activated by a variation of the angular position of the float member when the liquid level rises. A level sensor of the type known as mercury switch is arranged inside the float member.

The known solutions reveal drawbacks that could jeopardise the proper actuation of the pump. In particular, it is complained the structural complexity of the motion transmission members, which could trigger the blocking of the float, thus disabling the switch device. Another drawback lies in the potential breaking of the connection member of the float due to the alternated motion of the same float.

### PRESENTATION OF THE INVENTION

The task of the present invention is to overcome the aforementioned problems, by providing a float switch device capable of safely performing the operations of starting and stopping submersible pumps and the like according to the liquid level.

Within this task, a further object of the present invention is to provide a float switch device which ensures the duration of the connection member of the same float over time.

Another object of the present invention is to provide a float switch device that has a simple construction and functional design, provided with a definitely reliable operation, a versatile use, as well as relatively economic cost.

The aforementioned objects are attained, according to the present invention, by the float switch device according to claim 1.

According to the present invention, the float switch device comprises a float member which is constrained to a flexible cable electrically connected to the driving member of the pump, said flexible cable being associated with a tilting support member, mounted in tilting manner on the outside of the body of the pump, forming a channel through which a section of said flexible cable is inserted axially passing through.

Preferably, said channel is defined by a sleeve.

Preferably, said sleeve is made of rigid material.

According to an embodiment of the invention, said channel is obtained diametrically with respect to a body of said tilting support member.

Advantageously, said body of the tilting support member comprises a ball cap or a disc having said channel, through which said flexible cable is inserted axially passing through.

Preferably, said tilting support member is mounted in tilting manner on an eccentric pin having, in use, a substantially horizontal axis.

Preferably, said tilting support member is constrained, in an adjustable position through said pin, along a longitudinal guide fixed to the body of the pump.

The support member is mounted in tilting manner on a pin having, in use, a substantially horizontal axis.

Preferably, the float member is provided with a switch member electrically connected to said flexible cable and actuatable by actuator means mobile according to the liquid level.

Preferably, said float provides for a hollow casing in which a seat is defined in which said actuator means are mobile.

Preferably, said actuator means comprise a metal ball element.

Preferably, said actuator means are predisposed to operate a rocker arm lever hinged inside said casing of the float, said rocker arm lever being predisposed to operate said switch member.

Preferably, the flexible cable carries at its free end a connector predisposed to be fitted into a socket obtained in a head that closes said body of the pump at the top part.

### BRIEF DESCRIPTION OF THE DRAWINGS

The details of the invention shall be more apparent from the description of the detailed description of a preferred embodiment of the float switch device for submersible pumps according to the invention, illustrated by way of example in the attached drawings, wherein:

FIGS. 1 and 2 respectively show a lateral view of a submersible pump provided with the float switch device according to the invention, in various operating conditions;

FIG. 3 shows an enlarged view of a detail of the switch device according to the invention;

FIGS. 4 and 5 show a lateral view of the float member of the switch device, partially sectioned to show the internal parts, respectively in the operating conditions of FIGS. 1 and 2.

### BEST MODE

With particular reference to such figures, the float switch device associated with a submersible pump 10 of the type comprising, in known manner, an impeller predisposed to be driven in rotation by a driving member, is indicated in its entirety with 1. The pump 10 has a substantially cylindrical-shaped body arranged with a substantially vertical axis, in use conditions. In the cylindrical-shaped body there are a delivery body 11, inside which the impeller is placed, and a motor body 12, predisposed to house the driving member.

The switch device 1 comprises a float member 2 associated with the body of the pump 10 for controlling the starting and stopping of the same pump 10 according to the liquid level in the recipient in which the pump is arranged.

The float member 2 is constrained to a flexible cable 3 electrically connected to the driving member of the pump 10. In particular, the flexible cable 3 carries at the free end a connector 4 predisposed to be fitted into a socket obtained in the head 13 that closes the body of the pump 10 at the upper part.

The flexible cable 3 is associated, in a substantially central position, with a tilting support member 5, mounted in tilting manner on the outside of the body of the pump 10, according to an articulation axis substantially horizontal in the use position. Such articulation axis is defined by a pin 6 for connecting the support member 5 to the body of the pump 10. In particular, such articulation axis is radial to the body of the pump 10.

In particular, the support member 5 provides a sleeve 7 through which the flexible cable 3 is axially inserted passing through. The sleeve 7 is made of rigid material and shapes, on an external side, a fin 70 defining the seat for coupling with the pin 6. The pin 6 is usefully constrained to a slide 71 having a position adjustable along a longitudinal guide 8 fixed to the body of the pump 10.

Basically, the sleeve 7 tilts, in use, on a vertical plane around an eccentric axis defined by the pin 6; such eccentric axis is perpendicular to the longitudinal axis of the sleeve 7, passing through a point external to the same sleeve 7. In particular, the vertical tilting plane of the sleeve 7 is tangential to the body of the pump 10.

The tilting support member 5 of the flexible cable 3 may be made differently depending on the specific needs. For example, the support member 5 may be made up of a ball cap or a disc having a diametrical channel through which the flexible cable 3 is axially inserted passing through. Such ball cap or such disc tilt about an eccentric pin which traverses them according to a perpendicular axis external to the aforementioned diametrical channel. The ball cap or the disc have a position adjustable along a guide slot vertically associated with the body of the pump.

The float 2 provides for a hollow casing 20 in which a metal ball element 22 is mobile in a seat 21. The ball element 22 is predisposed to operate a rocker arm lever 23 hinged inside the casing 20 of the float 2; the rocker arm lever 23 is predisposed to operate a switch 24 which is electrically connected to the driving member of the pump 10 through the flexible cable 3 and thus controls the starting and stopping thereof.

The functioning of the float switch device according to the invention is clear from the description above.

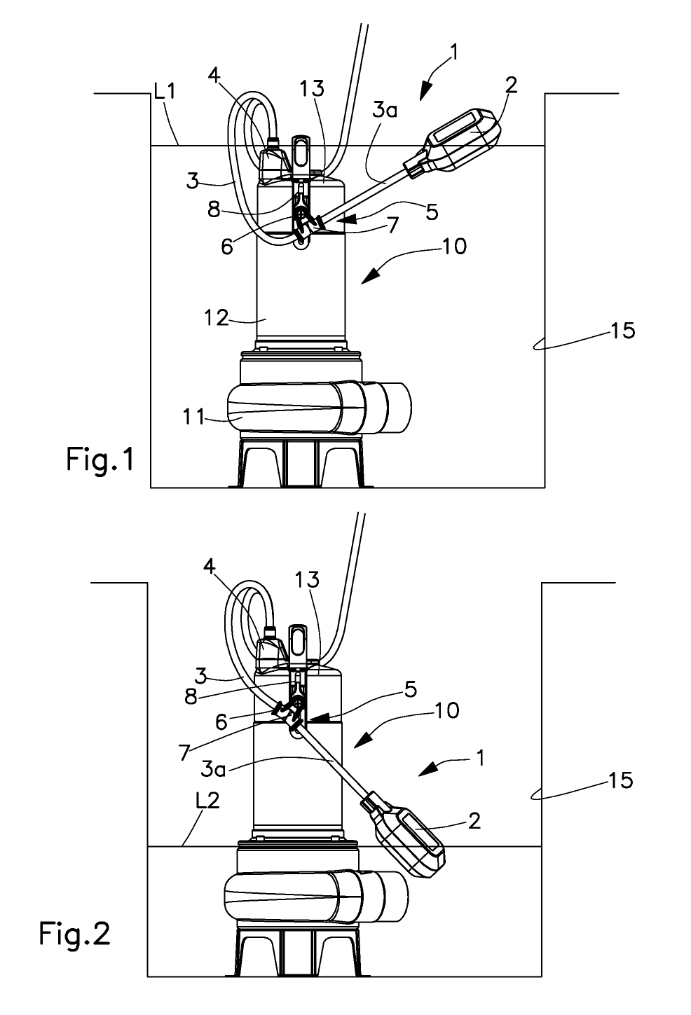

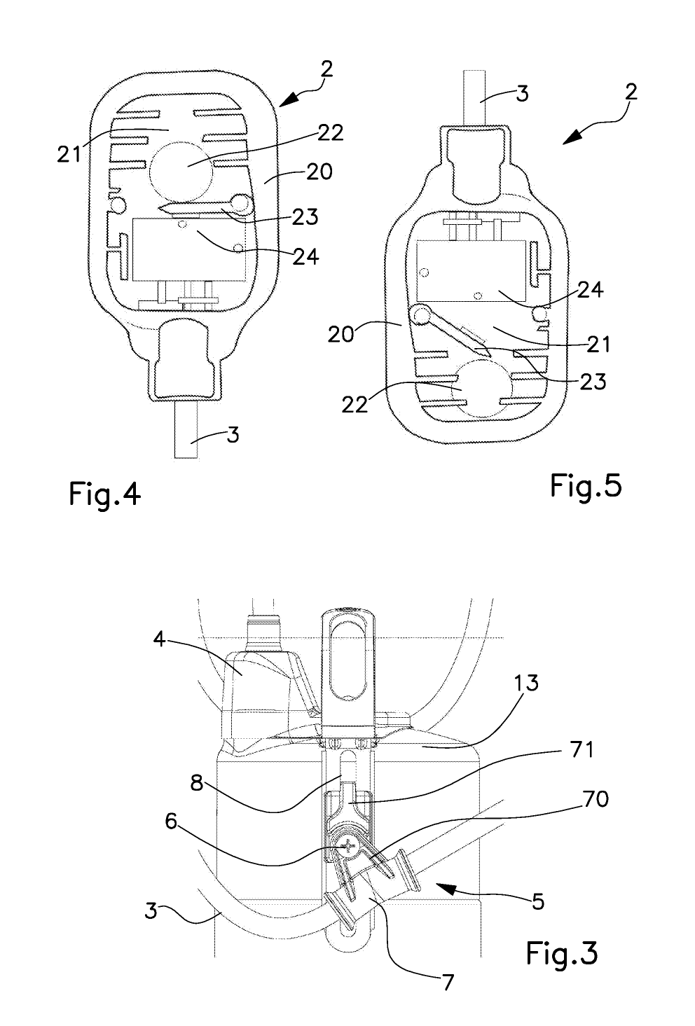

In use, the submersible pump 10 is arranged in the provided recipient for example in a well 15, in which the liquid has a variable level. The float 2 is kept at contact with the surface of the liquid, i.e. it rises or lowers depending on the variation of such level. In particular, the float switch device starts the pump when the liquid level reaches a preset height L1, as observable in FIG. 1, and stops it when the level drops to a minimum value L2, as observable in FIG. 2.

When the liquid is at the higher level L1, the inclination assumed by the float 2 is such that the ball 22 lies with its weight on the rocker arm lever 23 which operates the switch 24, thus starting the pump (see FIG. 4). Once the liquid level in the recipient drops, the arrangement of the float, the inclination thereof in particular, varies progressively until, at the preset minimum value L2 of the liquid, the ball element 22 is detached from the rocker arm lever 23 which operates the switch 24, thus stopping the pump (see FIG. 5).

The float switch device according to the invention attains the object of safely performing the starting and stopping operations of submersible pumps and the like according to the liquid level.

A distinctive feature of the switch device according to the invention lies in the fact that the flexible cable 3 is externally fixed to the pump 10 by the tilting support member 5, mounted in tilting manner and freely rotatable on a pin 6 which has, in use, a substantially horizontal axis. Thus, such support member 5 follows the angular rotation of the portion 3a of the flexible cable 3 which projects from the sleeve 7, upon the variation of the liquid level. In particular, the sleeve 7 is kept substantially aligned with such portion 3a of the flexible cable 3; such portion 3a of the flexible cable 3 is substantially aligned with the float 2.

This prevents the flexible cable 3 from being bent during the reciprocating movement of the float and thus from being subjected to mechanical stress that could lead to the flexible cable 3 breaking over time.

In addition, the flexible cable 3 is not subjected, in use, to flexures that could alter the inclination of the float 2 and thus the correct operation of the switch 24.

Another advantage of the switch device according to the invention lies in the fact that the aforementioned portion 3a of the flexible cable 3 that projects from the sleeve 7 is relatively small. This allows a proper functioning even in a small well.

A further advantage of the switch device in question lies in the fact that the tilting support member 5 has a position that is easily adjustable along the longitudinal guide 8 fixed to the outside of the body of the pump 10. This allows arranging the float in the most suitable position depending on the use conditions.

The switch device described by way of example can be subjected to numerous modifications and variants according to the various needs.

In the practical implementation of the invention, the materials used as well as the sizes may vary according to the needs.

Should the technical characteristics mentioned in the claims be followed by reference signs, such reference signs were included with the sole purpose of increasing the understanding of the claims and thus they shall not be deemed limiting the scope of the element identified by such reference signs by way of example.

1. A float switch device for submersible pumps, the float switch device comprising:
a float member associated with a body of a pump for controlling starting and stopping of said pump as a function of a liquid level, said float member comprising a switch member electrically connected to a motor member of said pump via a flexible cable which is associated with a tilting support member mounted in a tilting manner on an outside of said body of said pump on a pin with a substantially horizontal axis, said support member comprising a sleeve, said flexible cable being longitudinally inserted in said sleeve and said flexible cable passing through said sleeve.

2. A device according to claim 1, wherein said sleeve is constrained, in an adjustable position, through said pin, along a longitudinal guide which is fixed to said body of said pump.

3. A device according to claim 1, wherein said float comprises a hollow casing, wherein a seat is defined inside said hollow casing, wherein an actuator means is arranged in said seat for actuating said switch member, said actuating means being movable as a function of said liquid level.

4. A device according to claim 3, wherein said actuator means comprises a metal ball element.

5. A device according to claim 3, wherein said actuator means is predisposed to operate a rocker arm lever hinged inside said hollow casing of said float, said rocker arm lever being predisposed to operate said switch member.

6. A device according to claim 1, wherein said pin is associated with said tilting support member in an eccentric position with respect to said sleeve.

7. A device according to claim 6, wherein said support member comprises a fin defining a coupling seat for coupling with said pin, said fin being shaped on an external side of said sleeve.

8. A device according to claim 6, wherein said tilting support member comprises a ball cap or a disc having a diametrical channel, said flexible cable being inserted in said diametrical channel and said flexible cable passing through said diametrical channel, said pin traversing said ball cap or said disc according to an axis external to said diametrical channel.

9. A device according to claim 1, wherein said flexible cable comprises a free end, said free end carrying a connector at said free end, said connector being predisposed to be fitted into a socket obtained in a head that closes said body of said pump at a top part.

10. A device according to claim 1, wherein said sleeve is made of rigid material.

11. A device according to claim 4, wherein said actuator means is predisposed to operate a rocker arm lever hinged inside said hollow casing of said float, said rocker arm lever being predisposed to operate said switch member.
